(19) United States
(12) Patent Application Publication
(10) Pub. No.: US 2026/0056496 A1
(43) Pub. Date: Feb. 26, 2026

(54) IMAGE FORMING APPARATUS

(71) Applicant: CANON KABUSHIKI KAISHA, Tokyo (JP)

(72) Inventor: HIROHISA NAKAJIMA, Ibaraki (JP)

(21) Appl. No.: 19/304,009

(22) Filed: Aug. 19, 2025

(30) Foreign Application Priority Data
Aug. 22, 2024 (JP) 2024-140651

(51) Int. Cl. G03G 15/00; G03G 15/01; G03G 15/043; G03G 15/16; G06K 15/02

(52) U.S. Cl. CPC G03G 15/5029; G03G 15/011; G03G 15/0131; G03G 15/0189; G03G 15/043; G03G 15/167; G03G 15/502; G03G 15/6558; G06K 15/021; G03G 2215/00447; G03G 2215/00476

(57) ABSTRACT

An image forming apparatus includes an image bearing member, an image former configured to form an image on the image bearing member, a transfer unit configured to transfer, onto a recording material, the image formed on the image bearing member, a conveyor configured to convey the recording material to the transfer unit, a contact member which is provided upstream of the transfer unit in a conveyance direction of the recording material, and which is configured to ground the recording material being conveyed to the transfer unit, and a controller configured to form an image on the recording material by controlling the image former to form the image on the image bearing member, and controlling the transfer unit to transfer the image from the image bearing member onto the recording material.

### BACKGROUND

### Field of the Technology

The present disclosure relates to an image forming apparatus such as a printer, a copying machine, and a multifunction peripheral.

### Description of the Related Art

An electrophotographic apparatus, an electrostatic recording apparatus, or a similar image forming apparatus develops an electrostatic latent image formed on a photosensitive drum, to thereby form a toner image. The toner image is transferred onto a recording material. The transfer onto a recording material is performed directly from the photosensitive drum, or indirectly from the photosensitive drum via an intermediate transfer belt. The case of indirect transfer via an intermediate transfer belt is described here.

A transfer unit for transferring a toner image from the intermediate transfer belt onto a recording material includes a transfer inner roller provided inside the intermediate transfer belt and a transfer outer roller provided outside the intermediate transfer belt. At the time of the transfer, a predetermined bias voltage is applied to the transfer inner roller. The bias voltage is controlled by constant-voltage control so as to be constant during the transfer. Through the constant-voltage control, a current flowing to the recording material during the transfer is adjusted to a constant current.

Metalized paper including a metal layer is sometimes used as the recording material. Stable transfer of a toner image is desired for metalized paper as well. However, compared to a recording material that is paper without a metal layer, metalized paper is high in conductivity and low in impedance. For that reason, a current flowing to metalized paper is unstable despite the transfer unit being under constant-voltage control, and stable transfer of a toner image to metalized paper is consequently difficult in some cases. In Japanese Patent Application Laid-open No. 2018-60072, there is disclosed an image forming apparatus that causes a stable current to flow to metalized paper during the transfer. This image forming apparatus stabilizes a current flowing to a recording material by providing a contact member in the vicinity of the transfer unit and bringing the recording material into contact with the contact member.

In the configuration of Japanese Patent Application Laid-open No. 2018-60072, the contact member is placed in the vicinity of the transfer unit. When the transfer unit and the contact member are too close to each other, electric discharge may occur between the transfer outer roller and the contact member. An electric discharge occurring during the transfer hinders normal transfer to cause a defective image. Accordingly, the contact member is required to be placed at a predetermined distance or farther from the transfer outer roller in order to prevent an electric discharge between the transfer outer roller and the contact member irrespective of the magnitude of a high voltage output from the transfer unit.

In a case in which the distance between the transfer outer roller and the contact member is much greater than the predetermined distance, in an area on a rear-end side of the recording material, the recording material may detach from the contact member during the transfer of a toner image. In this case, the loss of grounding of the recording material destabilizes a transfer current to hinder normal transfer, resulting in defective transfer on the rear-end side of the recording material.

### SUMMARY

An image forming apparatus according to one embodiment of the present disclosure includes an image bearing member, an image former configured to form an image on the image bearing member, a transfer unit configured to transfer, onto a recording material, the image formed on the image bearing member, a conveyor configured to convey the recording material to the transfer unit, a contact member which is provided upstream of the transfer unit in a conveyance direction of the recording material, and which is configured to ground the recording material being conveyed to the transfer unit, and a controller configured to form an image on the recording material by controlling the image former to form the image on the image bearing member, and controlling the transfer unit to transfer the image from the image bearing member onto the recording material, wherein the controller is configured to avoid, in a case where the recording material is of a first paper type, forming the image in an area of the recording material that passes through the transfer unit after the recording material leaves the contact member.

An image forming apparatus according to another embodiment of the present disclosure includes an image bearing member, an image former configured to form an image on the image bearing member, a transfer unit configured to transfer, onto a recording material, the image formed on the image bearing member, a conveyor configured to convey the recording material to the transfer unit, a contact member which is provided upstream of the transfer unit in a conveyance direction of the recording material, and which is configured to ground the recording material being conveyed to the transfer unit, and a controller configured to form an image on the recording material by controlling the image former to form the image on the image bearing member, and controlling the transfer unit to transfer the image from the image bearing member onto the recording material, wherein the controller is configured to set, in a case in which the recording material is of a first paper type, a rear-end-side margin area of the recording material which is on a rear-end side in a conveyance direction of the recording material and in which no image is to be formed, larger than the rear-end-side margin area in a case in which the recording material is of a second paper type higher in impedance than the first paper type.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram of an image forming apparatus.

FIG. 2 is an explanatory diagram of a configuration of a secondary transfer unit.

FIG. 3 is an explanatory diagram of metalized paper.

FIGS. 4A and 4B are explanatory diagrams of a phenomenon in which a passing portion current is unstable.

FIGS. 5A and 5B are diagrams of a configuration of an example including a contact member.

FIG. 6 is a flow chart for illustrating processing in image forming.

FIGS. 7A, 7B, and 7C are explanatory diagrams of images formed by the processing of FIG. 6.

FIG. 8 is a diagram of an explanatory setting screen.

### DESCRIPTION OF THE EMBODIMENTS

Now, referring to the accompanying drawings, description is given of at least one preferred embodiment of the present disclosure.

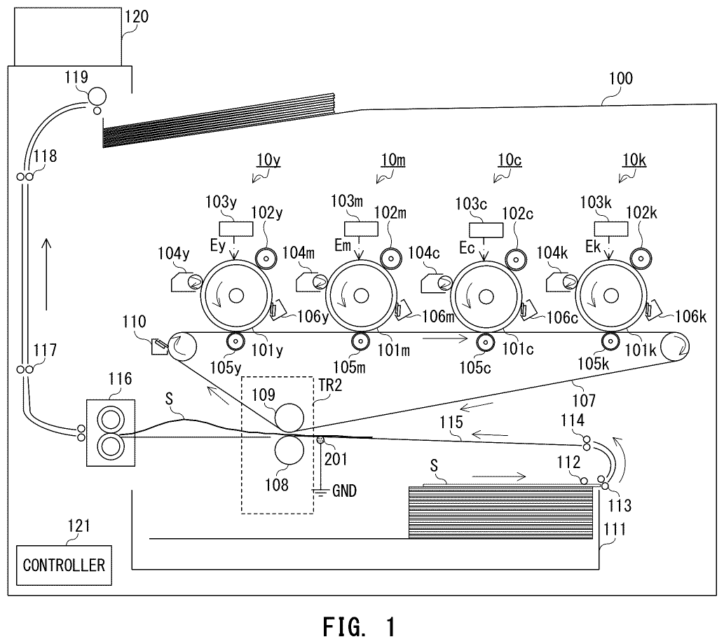

FIG. 1 is a configuration diagram of an image forming apparatus according to the at least one embodiment. An image forming apparatus 100 according to the at least one embodiment includes four image forming units, each of which serves as an image former. A first image forming unit 10y forms a yellow image, a second image forming unit 10m forms a magenta image, a third image forming unit 10c forms a cyan image, and a fourth image forming unit 10k forms a black image. The image forming units 10y, 10m, 10c, and 10k are the same as one another in configuration, except for the color of a toner used as a developer.

In FIG. 1, “y” at a tail end of a reference symbol indicates a component for forming a yellow image, “m” at a tail end of a reference symbol indicates a component for forming a magenta image, “c” at a tail end of a reference symbol indicates a component for forming a cyan image, and “k” at a tail end of a reference symbol indicates a component for forming a black image. Here, a configuration of the first image forming unit 10y which forms a yellow image is described, and a description on the configuration of the second, third, and fourth image forming units 10m, 10c, and 10k which form images of other colors is omitted.

The first image forming unit 10y includes a photosensitive drum 101y, a charging roller 102y, an exposure device 103y, a developing device 104y, a primary transfer roller 105y, and a photosensitive member cleaner 106y. The photosensitive drum 101y is a first image bearing member which is rotated in a direction of the arrow and which has a surface charged uniformly to a predetermined polarity and potential by the charging roller 102y. The exposure device 103y scans the charged surface of the photosensitive drum 101y with laser light Ey, which is modulated based on image data representing an image to be formed. An electrostatic latent image is thus formed on the surface of the photosensitive drum 101y. The developing device 104y develops the electrostatic latent image with use of a yellow toner to form a toner image on the surface of the photosensitive drum 101y.

Similarly, a magenta toner image is formed on a photosensitive drum 101m of the second image forming unit 10m. A cyan toner image is formed on a photosensitive drum 101c of the third image forming unit 10c. A black toner image is formed on a photosensitive drum 101k of the fourth image forming unit 10k.

An intermediate transfer belt 107 which is a second image bearing member is placed below the first to fourth image forming units 10y, 10m, 10c, and 10k. The intermediate transfer belt 107 is driven to rotate by a secondary transfer inner roller 109 which functions as a drive roller. A secondary transfer outer roller 108 is provided at a position that faces the secondary transfer inner roller 109 across the intermediate transfer belt 107. The secondary transfer inner roller 109 and the secondary transfer outer roller 108 form a secondary transfer unit TR2. An intermediate transfer belt cleaner 110 is placed on a side upstream of the first image forming unit 10y in a rotation direction of the intermediate transfer belt 107.

The toner images formed on the photosensitive drums 101y, 101m, 101c, and 101k, respectively, are transferred onto the intermediate transfer belt 107 on top of each other by the primary transfer roller 105y and primary transfer rollers 105m, 105c, and 105k, in time with the rotation of the intermediate transfer belt 107. Toners remaining on the photosensitive drums 101y, 101m, 101c, and 101k after the transfer are removed by the photosensitive member cleaner 106y and photosensitive member cleaners 106m, 106c, and 106k. The toner images transferred onto the intermediate transfer belt 107 are conveyed by the rotation of the intermediate transfer belt 107 to a side of the secondary transfer inner roller 109.

The image forming apparatus 100 includes a sheet feeding cassette 111 which stores a recording material S such as a sheet of paper on which an image is to be formed. In order to convey the recording material S stored in the sheet feeding cassette 111 to a conveyance path, the image forming apparatus 100 includes a guide member 115, a pickup roller 112, a sheet feeding roller pair 113, a registration roller pair 114, conveyance roller pairs 117 and 118, and a delivery roller 119. The pickup roller 112 feeds the recording material S stored in the sheet feeding cassette 111 to the conveyance path. The sheet feeding roller pair 113 separates sheets of the recording material S fed by the pickup roller 112 from one another and conveys one sheet at a time to the registration roller pair 114. The registration roller pair 114 corrects skewing of the recording material S. The registration roller pair 114 conveys the recording material S to the secondary transfer unit TR2 via the guide member 115, in time with conveyance of the toner images which have been transferred onto the intermediate transfer belt 107 to the side of the secondary transfer inner roller 109.

A contact member 201 is provided on a side upstream of the secondary transfer unit TR2 in a conveyance direction of the recording material S. The contact member 201 is a member for grounding the recording material S by coming into contact with the recording material S that is being conveyed. Details of the contact member 201 are described later.

The toner images of four colors borne on the intermediate transfer belt 107 are transferred onto the recording material S that is passing through a space between the secondary transfer inner roller 109 and the secondary transfer outer roller 108. A high voltage (bias voltage) of a predetermined level is applied to one of the secondary transfer inner roller 109 and the secondary transfer outer roller 108 to transfer the toner images from the intermediate transfer belt 107 onto the recording material S. Toners remaining on the intermediate transfer belt 107 after the transfer are scraped off and collected by the intermediate transfer belt cleaner 110.

The image forming apparatus 100 includes a fixing device 116 which fixes the toner images to the recording material S. The recording material S with the toner images transferred thereto is conveyed to the fixing device 116 by the secondary transfer outer roller 108. The fixing device 116 fixes the toner images to the recording material S by applying heat and pressure. The recording material S with the toner images fixed thereto is delivered to an outside of the image forming apparatus 100 via the conveyance roller pairs 117 and 118 and the delivery roller 119. The recording material S on which a color image has been formed (printed material) is thus obtained.

The image forming apparatus 100 is provided with a controller 121 for controlling operation of the above-mentioned components. The image forming apparatus 100 also includes, as a user interface including an input interface and an output interface, an operation unit 120. The operation unit 120 includes various keys or a touch panel as the input interface. The operation unit 120 includes a display and a speaker as the output interface. The controller 121 receives a user's instruction from the operation unit 120, or from an external apparatus via a network (not shown). When receiving a command of a print job (an image forming command), the controller 121 controls operation of the components as described above to execute operation of printing on the recording material S.

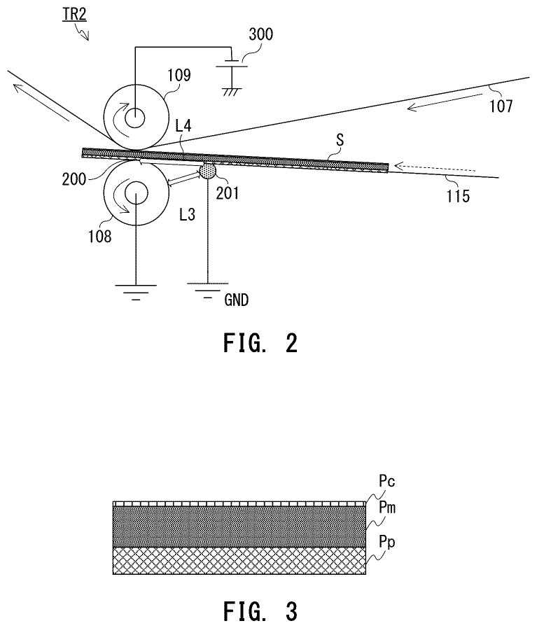

FIG. 2 is an explanatory diagram of a configuration of the secondary transfer unit TR2. The solid line arrows of FIG. 2 indicate a rotation direction of the intermediate transfer belt 107 and rotation directions of the secondary transfer outer roller 108 and the secondary transfer inner roller 109 in transfer of the toner images onto the recording material S. The broken line arrow indicates a conveyance direction of the recording material S.

The contact member 201 provided in the vicinity of the secondary transfer unit TR2 is a conductive member, and is placed so as to come into contact with one surface of the recording material S having been conveyed on the guide member 115 (a surface on an opposite side from a surface onto which the toner images are transferred). The contact member 201 is grounded, and the recording material S is accordingly grounded as well. The contact member 201 is placed so as to come into contact with at least one place of the recording material S in a case where the recording material S comes into contact with the secondary transfer outer roller 108.

The secondary transfer outer roller 108 and the secondary transfer inner roller 109 form a nip portion 200. In the nip portion 200, the intermediate transfer belt 107 and the recording material S are conveyed in a nipped state at the time of the transfer. In the at least one embodiment, a bias voltage having a potential of the same polarity as that of the toners (a negative potential in the at least one embodiment) is applied to the secondary transfer inner roller 109, to thereby transfer the toner images from the intermediate transfer belt 107 onto the recording material S. The bias voltage is controlled by constant-voltage control in order to stabilize a current flowing to the recording material S during the transfer.

Current flow in the nip portion 200 formed by the secondary transfer outer roller 108 and the secondary transfer inner roller 109 includes a current flowing in a portion in which the recording material S does not pass (a non-passing portion current) in a direction intersecting the conveyance direction of the recording material S (the intersecting direction is hereinafter referred to as “width direction”), and a passing portion current flowing in a portion in which the recording material S passes in the width direction. A current value of a current flowing in the secondary transfer unit TR2 is a sum value of the non-passing portion current and the passing portion current. A ratio of the non-passing portion current and the passing portion current varies depending on a resistance value which depends on the size and quality of the recording material S.

Accordingly, with constant-current control that keeps the current flowing in the secondary transfer unit TR2 constant, it is difficult to stabilize the passing portion current. For that reason, constant-voltage control is employed for the secondary transfer unit TR2. When impedance of the secondary transfer outer roller 108 decreases, the non-passing portion current increases and hinders a flow of the passing portion current of a desired magnitude. The secondary transfer outer roller 108 is accordingly set to impedance higher than impedance of the recording material S.

The secondary transfer inner roller 109 is set to impedance lower than the impedance of the recording material S. As described above, a high voltage (bias voltage) generated by a high-voltage power source 300 is applied to the secondary transfer inner roller 109. The secondary transfer outer roller 108 is higher in impedance than the recording material S, and has a roller axis that is grounded. The length of the secondary transfer outer roller 108 in the width direction may be longer than the length of the recording material S in the width direction. This is for ensuring that the transfer of the toner images is possible for the entire stretch of the recording material S in the width direction. In a case in which the impedance of the secondary transfer outer roller 108 is lower than the impedance of the recording material S, an undesired current flow to the non-passing portion occurs and makes the transfer of the toners onto the recording material S impossible. The impedance of the secondary transfer outer roller 108 is accordingly set higher than the impedance of the recording material S.

A high voltage is applied to the secondary transfer outer roller 108 via the secondary transfer inner roller 109. A maximum voltage applied to the secondary transfer outer roller 108 is about −8 kV. In order to prevent an electric discharge from occurring between the secondary transfer outer roller 108 and the contact member 201 at the time of application of the high voltage, the contact member 201 may be placed at a predetermined distance or farther from the secondary transfer outer roller 108. In the at least one embodiment, a gap between the secondary transfer outer roller 108 and the contact member 201 is a distance L3 (here, 10 mm).

With the gap between the secondary transfer outer roller 108 and the contact member 201 set to the distance L3, a gap between the nip portion 200 and the contact member 201 is a distance L4 (here, 15 mm). That is, the recording material S is kept in contact with the contact member 201 from the time when a front end of the recording material S in the conveyance direction is nipped by the nip portion 200 to the time when a point in the recording material S that is reached by moving from a rear end of the recording material S in the conveyance direction toward the front end by the distance LA is nipped by the nip portion 200. As the point reached by moving from the rear end toward the front end of the recording material S by the distance LA finishes passing through the nip portion 200, the recording material S becomes detached from the contact member 201. In the following description, the front end in the conveyance direction is simply referred to as “front end,” and the rear end in the conveyance direction is simply referred to as “rear end.”

The image forming apparatus 100 may form an image on the recording material S that includes a metal layer, such as metalized paper. FIG. 3 is an explanatory diagram of metalized paper. A sectional view of metalized paper is shown in FIG. 3. Metalized paper is generally configured from three layers. The metalized paper in an example of FIG. 3 is configured from three layers that are a plain paper layer Pp, a metal layer Pm, and a coating layer Pc. The metal layer Pm which is the second layer is formed of metal, for example, aluminum, and is deposited by vapor deposition process on the plain paper layer Pp which is the first layer. Being formed of metal, the metal layer Pm is superior in conductivity to the plain paper layer Pp, and is very low in impedance.

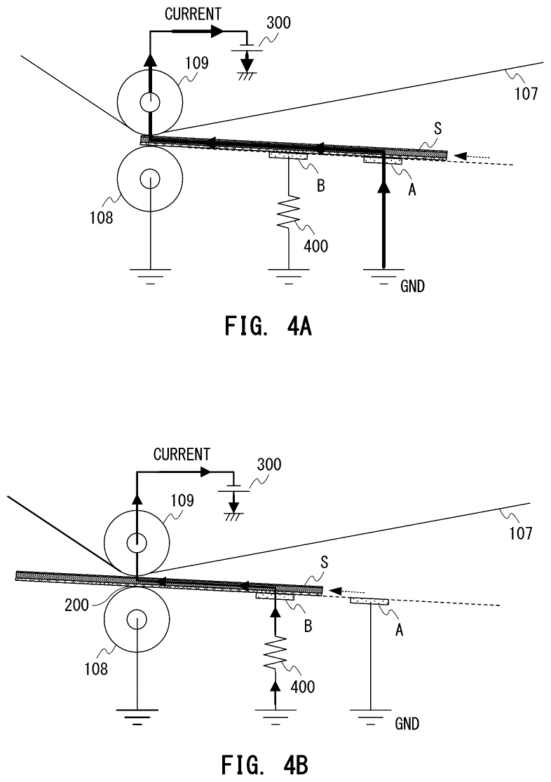

When the thus configured metalized paper passes through the nip portion 200, the passing portion current is known to be unstable despite the secondary transfer unit TR2 being under constant-voltage control. FIGS. 4A and 4B are explanatory diagrams of the phenomenon in which the passing portion current is unstable. In FIGS. 4A and 4B, a configuration of the related art that lacks the contact member 201 is illustrated, and guide members A and B are provided on a side upstream of the secondary transfer unit TR2 in the conveyance direction of the recording material S. The metalized paper is conveyed to the secondary transfer unit TR2 via the guide members A and B.

The guide member A is configured from a material lower in impedance than the secondary transfer outer roller 108, and is grounded. The guide member B is configured from a member that has predetermined impedance (here, impedance of a resistor 400). The solid line arrows of FIGS. 4A and 4B indicate a path of currents (the non-passing portion current and the passing portion current) flowing in the secondary transfer unit TR2. The broken line arrows indicate the conveyance direction of the recording material S (metalized paper).

FIG. 4A is an illustration of a state in which the front end of the metalized paper has reached the nip portion 200 of the secondary transfer unit TR2. The currents flow from the grounded guide member A through the metal layer Pm of the metalized paper to the secondary transfer inner roller 109 because the guide member A is lower in impedance than the secondary transfer outer roller 108.

At this point, load impedance viewed from the secondary transfer unit TR2 is substantially a sum value of impedance of the guide member A, the metalized paper, the intermediate transfer belt 107, and the secondary transfer inner roller 109. That is, the load impedance is substantially a sum value of impedance values given below. Currents depending on the load impedance flow in the secondary transfer unit TR2 because the secondary transfer unit TR2 is under constant-voltage control.
Contact impedance of a place at which the guide member A and the metalized paper are in contact with each other
Longitudinal impedance down the layers of the metalized paper
Contact impedance of a place at which the intermediate transfer belt 107 and the secondary transfer inner roller 109 are in contact with each other
Impedance of the secondary transfer inner roller 109

FIG. 4B is an illustration of a state in which the metalized paper has been conveyed further from the state of FIG. 4A. With the rear end having passed the guide member A, the metalized paper is no longer in contact with the guide member A. The currents flowing in the secondary transfer unit TR2 accordingly flow from the guide member B, which is grounded via the resistor 400, to the secondary transfer inner roller 109 via the metal layer Pm of the metalized paper. At this point, the load impedance viewed from the secondary transfer unit TR2 is substantially a sum value of the following impedance values.
Impedance of the resistor 400 of the guide member B
Contact impedance of a place at which the guide member B and the metalized paper are in contact with each other
Longitudinal impedance down the layers of the metalized paper
Contact impedance of a place at which the intermediate transfer belt 107 and the secondary transfer outer roller 108 are in contact with each other
Impedance of the secondary transfer inner roller 109

Currents depending on the load impedance flow in the secondary transfer unit TR2 because the secondary transfer unit TR2 is under constant-voltage control. The load impedance of FIG. 4B is higher than the load impedance of FIG. 4A due to involvement of the resistor 400 of the guide member B, and the passing portion current accordingly decreases. Through this mechanism, the passing portion current flowing in the toners fluctuates with variations in which member is in contact with the metalized paper depending on a location to which the metalized paper is conveyed. This results in a failure to maintain transfer properties of the toner images, and the failure leads to defective transfer.

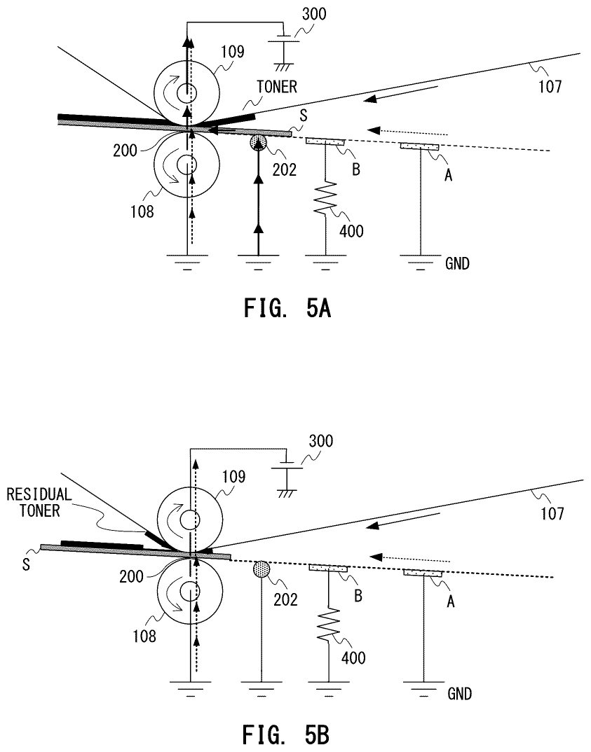

When a distance of the secondary transfer unit TR2 to the guide members A and B is equal to or greater than a predetermined distance, a contact member is sometimes provided between the secondary transfer unit TR2 and the guide member B. FIGS. 5A and 5B are diagrams of a configuration of an example includes a contact member, and the included contact member is a contact member 202 provided between the secondary transfer unit TR2 and the guide member B.

FIG. 5A is an illustration of a state in which the rear end of the metalized paper has passed the guide member B, and the metalized paper is nipped by the nip portion 200 of the secondary transfer unit TR2 and is in contact with the contact member 202. A current in this state has a sum value of the passing portion current that flows from the contact member 202 to the secondary transfer inner roller 109 through the metal layer Pm of the metalized paper and the non-passing portion current that flows from the secondary transfer outer roller 108 to the secondary transfer inner roller 109.

FIG. 5B is an illustration of a state in which the rear end of the metalized paper has passed the contact member 202 and the metalized paper is nipped by the nip portion 200 of the secondary transfer unit TR2. In this case, the load impedance of the secondary transfer unit TR2 rapidly increases to a level that stops the flow of the passing portion current. Transfer of the toner images to a rear-end side of the metalized paper is consequently defective.

As illustrated in FIG. 2, in a case where the recording material S is the metalized paper in the at least one embodiment, load impedance viewed from the high-voltage power source 300 differs before and after the rear end of the recording material S passes the contact member 201. That is, the load impedance during a period in which the recording material S is nipped by the nip portion 200 in some place from the front end of the recording material S to a point that precedes the rear end of the recording material S by the distance L4 (15 mm) is lower than the load impedance during a period in which the recording material S is nipped by the nip portion 200 in some place from the point that precedes the rear end of the recording material S by the distance LA to the rear end. This is because the recording material S (metalized paper) is grounded by being in contact with the contact member 201.

Thus, a significant change in impedance occurs depending on in which place the recording material S is nipped. The change in impedance causes defective transfer of the toner images onto the recording material S (metalized paper). In a case in which the recording material S is not a low-impedance material such as metalized paper, no current flows to the contact member 201 via the recording material S and, accordingly, the significant change in impedance does not occur.

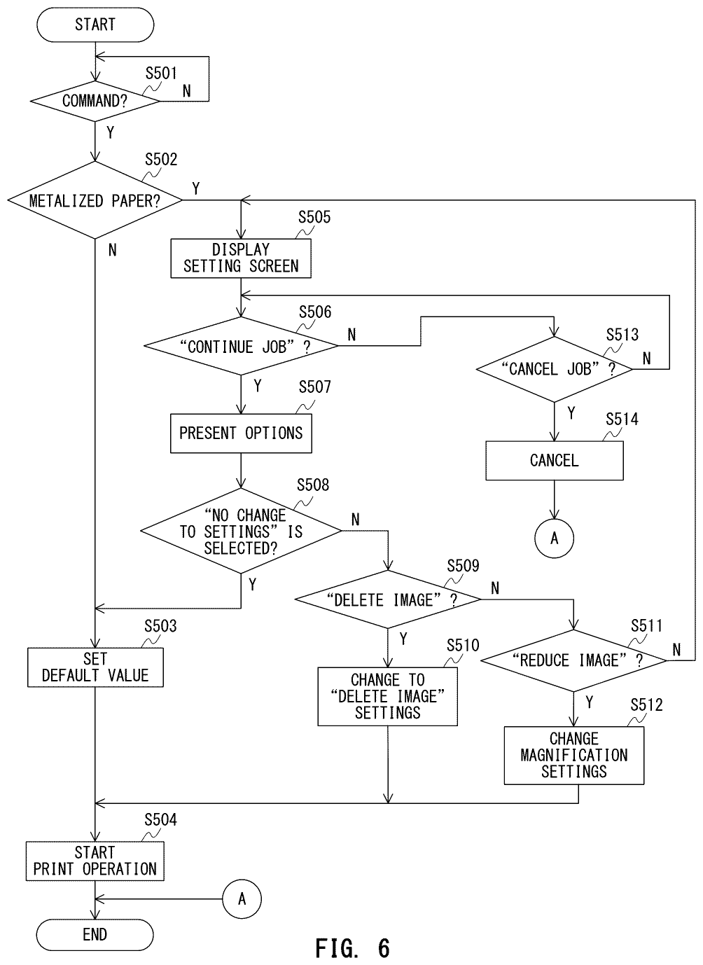

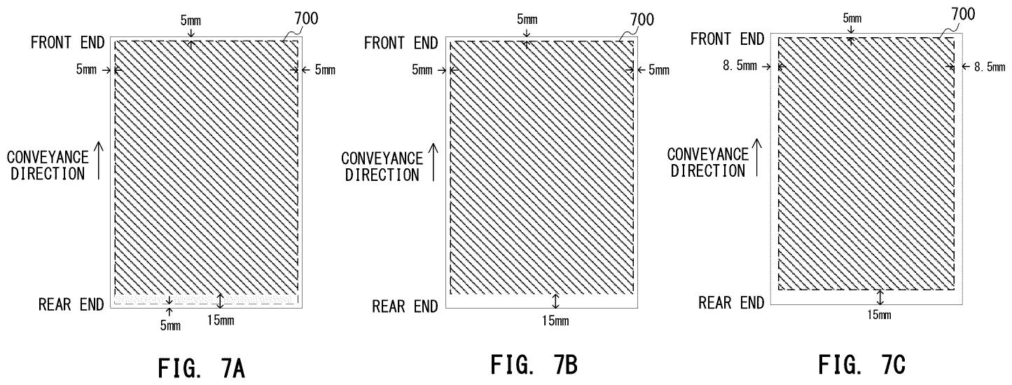

FIG. 6 is a flow chart for illustrating processing in image forming. This processing is for transferring the toner images free of defective transfer until a rear-end portion of the recording material S is reached even when the recording material S is formed from a material lower in impedance than plain paper. Here, a case in which the recording material S is metalized paper is described. FIGS. 7A to 7C are explanatory diagrams of images formed by the processing of FIG. 6.

As the image forming apparatus 100 starts to operate, the controller 121 checks whether a command of a print job has been acquired from the operation unit 120 of the image forming apparatus 100, or from an external apparatus via a network (Step S501). When the command has not been acquired (Step S501: N), the controller 121 stands by until the command is acquired.

In a case where the command has been acquired (Step S501: Y), the controller 121 checks a paper type of the recording material S that is stored in the sheet feeding cassette 111 and that is to be used in the print job, and determines whether the recording material S is metalized paper or not (Step S502). The paper type of the recording material S is checked by referring to setting values that are set by the user with use of the operation unit 120 in a case where the recording material S is stored in the sheet feeding cassette 111. The setting values include, for example, feature information (paper type, size, and the like) of the recording material S.

When the recording material S is not metalized paper (Step S502: N), the controller 121 sets margin areas of the recording material S in which no printing is performed to predetermined default values set in advance for the image forming apparatus 100 (Step S503). Margins of the recording material S that are set in advance for the image forming apparatus 100 are, for example, 5 millimeters (mm) for all of a front-end margin, a rear-end margin, a right-edge margin, and a left-edge margin. The controller 121 starts print operation in order to form an image in accordance with the print job (Step S504). When print operation instructed by the print job is finished, the controller 121 ends a series of processing steps in image forming that is suited to the print job.

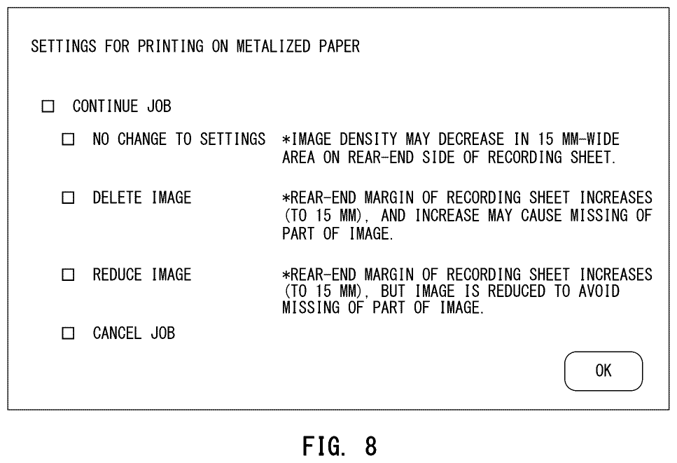

When the recording material S is metalized paper (Step S502: Y), the controller 121 displays, on the display of the operation unit 120, a setting screen concerning print settings for printing on metalized paper as illustrated in FIG. 8 (Step S505). This setting screen indicates a possibility of a decrease in image density of an image in an area that stretches for a predetermined distance (here, 15 mm) from the rear end of the recording material S toward the front-end side.

When “continue job” is selected (Step S506: Y), the controller 121 presents options to choose from which are “no change to settings,” “delete image,” and “downscale image” (Step S507). The “delete image” option means that, when there is image data representing the image to be formed in the area that stretches for 15 mm from the rear end of the recording material S toward the front-end side, use of the image data in image forming is prohibited. That is, “delete image” is an option that tolerates missing of a part of an image on the rear-end side. “Downscale image” is an option to reduce the image in size so that no image is formed in the area that stretches for 15 mm from the rear end of the recording material S toward the front-end side. Specifically, “downscale image” is settings under which entirety of an image to be formed on the recording material S finishes being formed on the recording material S by the time the recording material S leaves the contact member 201, and there is no image left to be formed in the area that stretches for 15 mm from the rear end of the recording material S toward the front-end side. “No change to settings” is an option not to “delete image” and not to “downscale image,” and there is a possibility of decrease in density of the image in the area that stretches for 15 mm from the rear end of the recording material S toward the front-end side. “Cancel job” is an option not to execute printing on the metalized paper. The user selects suitably from those options with use of the operation unit 120.

When “no change to settings” is selected (Step S508: Y), the controller 121 sets the margins of the recording material S to the default values set in advance for the image forming apparatus 100, and starts print operation in order to form an image in accordance with the print job (Step S503 and Step S504). When the print operation instructed by the print job is finished, the controller 121 ends the series of processing steps in image forming that is suited to the print job.

FIG. 7A is an illustration of an exemplary image that is formed on the recording material S in this case. This image is a printed image (hatched image) of a case in which an image is formed in entirety of an image formable area 700 of the recording material S at a uniform image density. The image of FIG. 7A decreases in image density in the area that stretches for a predetermined distance (here, 15 mm) from the rear end of the recording material S toward the front-end side. This is because, as the recording material S leaves the contact member 201, a current (transfer current) flowing to the recording material S decreases and the toners that are transferred consequently decrease in amount.

When “no change to settings” is not selected (Step S508: N), the controller 121 determines whether “delete image” is selected (Step S509). When “delete image” is selected (Step S509: Y), the controller 121 changes settings so that no image is formed in the area that stretches for 15 mm from the rear end of the recording material S toward the front-end side (Step S510). For example, the controller 121 changes settings of the margin areas so that, out of image data representing the image, image data corresponding to the image in the area that stretches for 15 mm from the rear end of the recording material S toward the front-end side is not used in image forming. In this case, an area on the photosensitive drum 101 that corresponds to the area stretching for 15 mm from the rear end of the recording material S toward the front-end side is not exposed to light. Alternatively, developing is prevented in the area on the photosensitive drum 101 by applying no development bias to the area. A still another way is to prevent transfer of the toner images in the area on the photosensitive drum 101 by applying no transfer bias to the area. Accordingly, even when there is image data representing the image that is to be formed in the area stretching for 15 mm from the rear end of the recording material S toward the front-end side, the part of the image is missing from the area. After changing the settings, the controller 121 starts print operation for forming the image in accordance with the print job (Step S504). When the print operation instructed by the print job is finished, the controller 121 ends the series of processing steps in image forming that is suited to the print job.

FIG. 7B is an illustration of an exemplary image that is formed on the recording material S in the case in which the settings of Step S510 are set. In this image, there is no image formed in the area that stretches for 15 mm from the rear end of the recording material S toward the front-end side. That is, the part of the image of FIG. 7A that is in the area varied in image density is not formed in FIG. 7B. Accordingly, a printed image without fluctuations in image density can be obtained. The rear-end margin may avoid being less than the distance LA described above, and may be 16 mm.

When an option other than “delete image” is selected (Step S509: N), the controller 121 determines whether “downscale image” is selected (Step S511). When “downscale image” is selected (Step S511: Y), the controller 121 changes (reduces) magnification settings of the image so that no image is formed in the area that stretches for 15 mm from the rear end of the recording material S toward the front-end side (Step S512). After changing the settings, the controller 121 starts print operation for forming the image in accordance with the print job (Step S504). When the print operation instructed by the print job is finished, the controller 121 ends the series of processing steps in image forming that is suited to the print job.

How a magnification of an image is changed is described by taking a case of forming an image on the recording material S sized A4 (210 mm×297 mm) as an example. Paper sizes are noted in the form of “(the length in the width direction, the length in the conveyance direction).” In the case of the recording material S sized A4, the default margin settings (5 mm in all directions) leave 200 mm×287 mm as the size of the image formable area 700.

In the case in which the recording material S is metalized paper, an inside of the area that stretches for 15 mm from the rear end of the recording material S toward the front-end side is unusable for image forming, and a resultant length of the image formable area 700 in the conveyance direction of the recording material S is 277 mm. Accordingly, the magnification of the image is changed to 277/287, which is approximately 96.5%. The image is downscaled to 96.5% in the width direction. This gives 193 mm×277 mm as the size of the formed image. FIG. 7C is an illustration of an exemplary image that is formed on the recording material S (metalized paper) in the case in which the settings of Step S512 are set.

When the selected option is not “downscale image” (Step S511: N), the controller 121 repeatedly executes Step S505 and subsequent processing steps. When “continue job” is not selected (Step S506: N), the controller 121 determines whether “cancel job” is selected (Step S513). When “cancel job” is selected (Step S513: Y), the controller 121 cancels the job and ends the processing (Step S514). When “cancel job” is not selected (Step S513: N), the controller 121 repeatedly executes Step S506 and subsequent processing steps.

As described above, in a case where the recording material S is metalized paper, no image is formed in an area of the recording material S on the rear-end side that passes through the nip portion 200 after the rear end of the recording material S leaves the contact member 201. This prevents a defective image that is caused by defective transfer of a toner image onto the rear-end side of the recording material S in a case where an image is to be formed on metalized paper. Although the description given above takes metalized paper as an example of the recording material S of this kind, the at least one embodiment is effective for any recording material S of a first paper type that has impedance lower than a predetermined value and that may be grounded by the contact member 201 in order to avoid the adverse effect on transfer of a toner image. In a case in which the recording material S is of a second paper type which is higher in impedance than the first paper type, an image is formed in an area of the recording material S on the rear-end side that passes through the nip portion 200 after the rear end of the recording material S leaves the contact member 201.

In the at least one embodiment, settings (image data) are changed for an image to be formed in the area that stretches for 15 mm from the rear end of the recording material S toward the front-end side so that the part of the image is deleted or so that the magnification is changed. Another way to obtain the same effect is inhibiting the exposure device 103y and exposure devices 103m, 103c, and 103k from emitting light.

Although a configuration in which the toner images are transferred onto the recording material S by the secondary transfer unit TR2 is described in the at least one embodiment, the at least one embodiment is effective also for a case in which the toner images are transferred onto the recording material S directly from the photosensitive drums 101y, 101m, 101c, and 101k. For example, some of image forming apparatus that form a monochromatic image have a configuration in which a toner image is transferred onto the recording material S directly from a photosensitive drum. Some of image forming apparatus that form a color image are also configured so as to transfer toner images onto the recording material S directly from a photosensitive drum by forming toner images of different colors on a single photosensitive drum one color at a time. The photosensitive drum and a primary transfer roller form a nip portion in which the toner image or the toner images are transferred onto the recording material S.

In this case, the contact member 201 is provided on a side upstream of the photosensitive drum in a conveyance direction of the recording material S. When the recording material S is of a paper type that may be grounded by the contact member 201 in order to avoid the adverse effect on transfer of the toner image(s), the controller 121 generates an image as exemplified in the illustrations of FIGS. 7B and 7C through the processing steps of from Step S505 to Step S512 of FIG. 6.

In the at least one embodiment, the screen illustrated in FIG. 8 is displayed after a job is received. However, the at least one embodiment may be modified so that print settings for metalized paper can be set in advance before a job is received. That is, the user sets one of the above-mentioned options which are “no change to settings,” “delete image,” and “downscale image” in advance, and, in a case where a job that is printing on metalized paper is received, the controller 121 executes the job based on the preset settings.

Alternatively, “delete image” or “downscale image,” for example, may be set as default settings for metalized paper so that, in a case where a job that is printing on metalized paper is received, the margin on the rear-end side of the recording sheet is automatically increased from the margin in a recording sheet other than metalized paper.

According to the present disclosure described above, normal transfer of a toner image is possible even for a recording material that has low impedance such as metalized paper. Further, according to the present disclosure, there is provided an image forming apparatus capable of normal transfer of a toner image even for a recording material that has low impedance such as metalized paper.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-140651, filed Aug. 22, 2024, which is hereby incorporated by reference herein in its entirety.

What is claimed is:

1. An image forming apparatus comprising:
an image bearing member;
an image former configured to form an image on the image bearing member;
a transfer unit configured to transfer, onto a recording material, the image formed on the image bearing member;
a conveyor configured to convey the recording material to the transfer unit;
a contact member which is provided upstream of the transfer unit in a conveyance direction of the recording material, and which is configured to ground the recording material being conveyed to the transfer unit; and
a controller configured to form an image on the recording material by controlling the image former to form the image on the image bearing member, and controlling the transfer unit to transfer the image from the image bearing member onto the recording material,
wherein the controller is configured to avoid, in a case where the recording material is of a first paper type, forming the image in an area of the recording material that passes through the transfer unit after the recording material leaves the contact member.

2. The image forming apparatus according to claim 1, wherein the controller is configured to control the image former to form an image in the area in a case where the recording material is of a second paper type higher in impedance than the first paper type.

3. The image forming apparatus according to claim 1, wherein the controller is configured to control, in a case where the recording material is of the first paper type, the image former so that use of image data corresponding to the image that is to be formed in the area is avoided in image forming.

4. The image forming apparatus according to claim 3,
wherein the image former includes an exposure unit configured to expose the image bearing member based on image data, and
wherein the controller is configured to inhibit the exposure unit from executing exposure based on image data corresponding to an image that is to be formed in the area.

5. The image forming apparatus according to claim 1, wherein the controller is configured to change, in a case where the recording material is of the first paper type, a magnification at which an image to be formed on the recording material is formed so that entirety of the image is formed on the recording material before the recording material leaves the contact member, with no the image being formed in the area.

6. The image forming apparatus according to claim 1,
wherein the transfer unit includes a first roller and a second roller, and is configured to:
convey the image bearing member and the recording material with the first roller and the second roller nipping the image bearing member and the recording material; and
transfer the image from the image bearing member onto the recording material by application of a predetermined bias voltage to the first roller,
wherein the contact member is placed at a predetermined distance or farther from the second roller so that electric discharge between the second roller and the contact member is prevented in a case where the predetermined bias voltage is applied.

7. The image forming apparatus according to claim 1, further comprising a display,
wherein the controller is configured to display, in a case where the recording material is of the first paper type, on the display, a first screen including an option for forming no image in the area.

8. The image forming apparatus according to claim 1, wherein the recording material of the first paper type is a recording material lower in impedance than a recording material that is plain paper.

9. The image forming apparatus according to claim 8, wherein the recording material of the first paper type is metalized paper including a metal layer deposited by a vapor deposition process.

10. An image forming apparatus comprising:
an image bearing member;
an image former configured to form an image on the image bearing member;
a transfer unit configured to transfer, onto a recording material, the image formed on the image bearing member;
a conveyor configured to convey the recording material to the transfer unit;
a contact member which is provided upstream of the transfer unit in a conveyance direction of the recording material, and which is configured to ground the recording material being conveyed to the transfer unit; and
a controller configured to form an image on the recording material by controlling the image former to form the image on the image bearing member, and controlling the transfer unit to transfer the image from the image bearing member onto the recording material,
wherein the controller is configured to set, in a case in which the recording material is of a first paper type, a rear-end-side margin area of the recording material which is on a rear-end side in a conveyance direction of the recording material and in which no image is to be formed, larger than the rear-end-side margin area in a case in which the recording material is of a second paper type higher in impedance than the first paper type.

11. The image forming apparatus according to claim 10, wherein the rear-end-side margin area in the case in which the recording material is of the first paper type has a length in the conveyance direction that is equal to or greater than a distance between the transfer unit and the contact member.

12. The image forming apparatus according to claim 10, wherein the recording material of the first paper type is a recording material lower in impedance than a recording material that is plain paper.

13. The image forming apparatus according to claim 12, wherein the recording material of the first paper type is metalized paper including a metal layer deposited by a vapor deposition process.
